(19) United States
(12) Patent Application Publication
(10) Pub. No.: US 2026/0281254 A1
(43) Pub. Date: Sep. 17, 2026

(54) SYSTEMS AND METHODS FOR DETECTING POTENTIALLY DEFECTIVE CONSUMABLES

(71) Applicant: Xerox Corporation, Norwalk, CT (US)

(72) Inventors: Eliud Robles Flores, Rochester, NY (US); Matthew Atvell, Rochester, NY (US); Fan Shi, Penfield, NY (US)

(21) Appl. No.: 19/081,125

(22) Filed: Mar. 17, 2025

(51) Int. Cl. H04N 1/00; G06F 3/12; H04N 1/32

(52) U.S. Cl. CPC H04N 1/00034; G06F 3/1205; G06F 3/121; G06F 3/1254; H04N 1/00079; H04N 1/0092; H04N 1/32539; H04N 2201/0094

(57) ABSTRACT

Systems and methods for operating a system including a plurality of machines having consumables of at least one consumable batch installed therein. The methods comprise: obtaining, by a computing device, voltage or light based bare belt readings taken by sensors during one or more print or copy processes performed by the plurality of machines; using, by the computing device, the voltage or light based bare belt readings to determine whether the at least one consumable batch is a good batch or a bad batch; and performing, by the computing device, one or more actions to control operations of the plurality of machines and/or replace the consumables in the plurality of machines in response to a determination that the at least one consumable batch is a bad batch.

### BACKGROUND

### Description of the Related Art

Print engines today are expected to be smart, self-healing, or—at the very least—predictive, for example, to warn the customer, service representative and/or printer manufacturer of potential issues. This is especially true around consumables. Consumables such as toner/ink or photoreceptors/drums are crucial to the printing engine. A bad, defective, or low-quality batch is undesirable in most applications.

### SUMMARY

The present disclosure concerns implementing systems and methods for operating a system including a plurality of machines having consumables of at least one consumable batch installed therein. The methods comprise: obtaining, by a computing device, light based and voltage based bare belt readings taken by sensors during one or more print or copy processes performed by the plurality of machines; using, by the computing device, the light based and voltage based bare belt readings to determine whether the at least one consumable batch is a good batch or a bad batch; and performing, by the computing device, one or more actions to control operations of the plurality of machines and/or replace the consumables in the plurality of machines in response to a determination that the at least one consumable batch is a bad batch.

The present disclosure also concerns a system, comprising: a plurality of machines having consumables of at least one consumable batch installed therein and sensors that take light based and voltage based bare belt readings during print or copy jobs; a processor; and a non-transitory computer-readable medium. The non-transitory computer-readable medium comprises one or more programming instructions that when executed by the processor, cause the processor to: obtain the light based and voltage based bare belt readings taken by the sensors during one or more print or copy processes performed by the plurality of machines; use the light based and voltage based bare belt readings to determine whether the at least one consumable batch is a good batch or a bad batch; and perform one or more actions to control operations of the plurality of machines and/or replace the consumables in the plurality of machines in response to a determination that the at least one consumable batch is a bad batch.

### BRIEF DESCRIPTION OF THE DRAWINGS

The present solution will be described with reference to the following drawing figures, in which like numerals represent like items throughout the figures.

FIG. 1 provides an illustration of a system implementing the present solution.

FIGS. 2A-2C and 3 each provides a flow diagram of an illustrative method for operating a system implementing the present solution. FIGS. 2A-2C are collectively referred to as “FIG. 2”.

FIG. 4 provides a block diagram of an illustrative architecture for a computing device.

### DETAILED DESCRIPTION

Xerographic devices are configured to produce an image by applying a marking material (e.g., toner or dry ink) to a latent image on a photoreceptor (belt or drum). A transfer device transfers the developed marking material to a media sheet or image transfer belt to provide a developed image. A fuse assembly then affixes or fuses the developed image to the media sheet by applying heat and/or pressure to the media sheet. Predicting failures in print engines (before they actually occur) is of utmost importance and can save significant costs to the corporation. This is especially true in xerographic engines due to their complexity.

Current methods for predicting failures in most print engines lack ‘smartness’. This is not due to insufficient data but rather because the data is very complicated and convoluted. The field may have hundreds or thousands of machines producing data under varied circumstances. The workload falls on engineers and service technicians to realize the Inception of something bad happened, when is mostly too late: the field Impact is evident, the Symptoms are real, and the Result is obvious.

The present solution provides a novel technique to detect or predict bad batches of consumables in a more efficient and timely manner using bare belt voltage or light based readings. The consumables include, but are not limited to, photoreceptor drums, photoreceptor belts, and toner cartridges. The particulars of the novel technique will become evident as the discussion progresses.

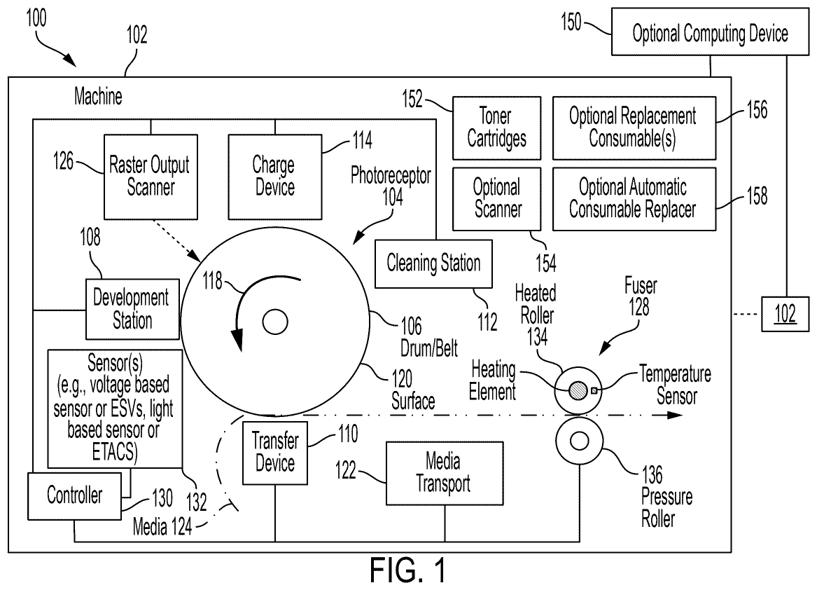

FIG. 1 provides an illustration of a system 100 implementing the present solution. System 100 comprises one or more machines 102 with a media transport 122. The term “machine”, as used herein, refers to a device whose performance is being monitored. Each machine can include, but is not limited to, a xerographic print engine, a xerographic printer, a xerographic multifunction media device, a xerographic machine, or other xerographic device that produces images on media sheets. The media sheets can include, but are not limited to, paper, substrates, transparencies, plastic, cardboard, and/or other media sheets.

The media transport 122 is configured to transport media or an intermediate transfer belt or drum 124. The machine 102 may also comprise a photoreceptor 104. The photoreceptor 104 can be a belt or drum 106 and have a photoreceptor charge transport surface 120 for forming electrostatic images thereon. The photoreceptor 104 is configured to rotate in the direction shown by arrow 118 and generate an image on the media sheet(s) being transported by the media transport's belt or drum 124.

The machine 102 also comprises a charger device 114 that can apply a first voltage V₁ to the photoreceptor 104. The charger device 114 can include, but is not limited to, a scorotron, a charge roll, or any other electric field generation device. The charger device 114 is configured to impart an electrostatic charge on the surface 120 as the photoreceptor 104 rotates.

A raster output scanner 126 is configured to discharge selected areas of the photoreceptor surface 120 according to the desired image to be printed. The selected portions of the photoreceptor surface 120 can be discharged to a lower second voltage V₂. The raster output scanner 126 can include, but is not limited to, a laser source, a rotatable mirror, light-lens system, and/or a Light Emitting Diode (LED) bar.

A development station 108 is configured to develop an exposed latent image by applying a third voltage V₃ after selected areas of the photoreceptor surface 120 are discharged. The third voltage may have a magnitude in between V₁ and V₂. The application of the third voltage V₃ causes a supply of marking material to contact or otherwise approach the exposed latent image on the photoreceptor surface 120. The marking material can include, but is not limited to, or toner.

A transfer device 110 transfers the developed marking material to a media sheet or image transfer belt to provide a developed image. In this regard, the transfer device 110 is configured to cause the marking material adhering to the photoreceptor surface 120 to be electrically transferred to media (e.g., the media sheet(s) or to the intermediate transfer belt or drum 124) to form the image thereon. The media with the toner image thereon can then be passed through a fuser 128. Fuser 128 is configured to cause the marking material to melt or fuse into the media to create the permanent image. This can be achieved through the application of heat to the media by a heated roller 134 and/or pressure to the media sheet by a pressure roller 136. The pressure roller 136 holds the media firmly against the heated roller 134 when the toner melts and adheres to the media. The heat and pressure may also cause the toner to melt and be pressed into media fibers.

Once the image is fused or permanently fixed to the sheet of media, a gate either allows the sheet to move directly via an output to a finisher or stacker, or deflects the sheet of media into a duplex path (not shown for ease of illustration).

After the copy sheet is separated from the photoconductive surface 120, cleaning station 112 is used to clean any residual marking material and/or paper from the photoconductive surface 120. The cleaning station 112 can include, but is not limited to, electrostatic cleaning brush(es) coupled to the photoreceptor surface 120, or a rubber cleaning blade in contact with the photoreceptor surface 120 to scrape any residual toner and/or paper from the photoreceptor surface. The photoreceptor surface 120 may be cleaned, for example, using an electric field generated between the fibers of the electrostatic cleaning brush(es) and the residual toner on the photoreceptor surface.

A controller 130 is provided to control operations of the machine 102. In this regard, controller 130 is electrically connected to components 104, 108-114, 122-128 of the machine 102. The controller 130 is configured to determine predict upcoming photoreceptor failure based on certain criteria. The controller 130 may also be configured to output an indicator that indicates the predicted failure and/or the need for an upcoming photoreceptor replacement. The indicator can be output visually, tactically or auditorily.

Sensors 132 may be provided to obtain voltage based or light based bare belt readings that may be used to detect, predict, notify, warn, prevent and/or remove a bad batch of photoreceptor drum/belts 106 and/or toner 152 in the field. The voltage based bare belt readings may be made by voltage measuring devices such as electrostatic voltmeters (ESVs) while the light based measurements are made by the extended toner area coverage sensors (ETACSs). Any known ESV and/or ETACS can be used here. An ESV measures the voltage potential of control patches on a photoconductive surface of the belt or drum. An example of an ESV is described in U.S. Pat. No. 6,426,630 to Werner, Jr. The ETACS sensors are light based sensors. The light based bare belt readings may be made by an ETAC in a location labeled as “background patch”. The light based bare belt readings may be stored in datastore(s) so as to be respectively associated with unique batch identifiers, unique toner cartridge identifiers, and/or unique photoreceptor drum or belt identifiers. The datastore(s) can include, but are not limited to, memory of controller 130, memory of a remote computing device 150, and/or a remote database accessible to machines 120 and/or remote computing device 150. The database may be accessed via a network (not shown for ease of illustration) (e.g., the Internet or Intranet). One or more of the listed unique identifiers may be obtained manually and/or electronically by scanner 154 via operations to scan barcodes on PR(s) 104, drum/belt(s) 106, and/or packaging thereof. One or more of the listed unique identifiers may be obtained electronically via a Customer Replaceable Unit Monitor or CRUM on the toner cartridges, bottles, and/or packaging thereof. The system uses the light based bare belt readings (i) to compute a relative reflectance (RR) variability (e.g., standard deviation and/or range) and/or a mean for a specific toner batch, and/or (ii) to compute a mean bare belt value and/or standard deviation for photoreceptor drum/belts 106 for a specific photoreceptor drum/belt batch. The computation of (i) facilitates the system's detection of (1) bare belt ETAC reading shifts (mean) and variability increases (standard deviation) as a function of toner batch. The computation of (ii) facilitates the system's detection of (1) bare belt ESV voltage shifts (mean) and variability increases (standard deviation) as a function of photoreceptor drum/belt batch and/or (2) exposed belt ESV voltage at black (K) station shifts (mean) and variability increases (standard deviation) as a function of photoreceptor drum/belt batch.

More specifically, controller 130 and/or a remote computing device 150 may be configured to use the voltage based bare belt readings in machines 102 to detect, predict and/or warn of a bad batch of drums/belts 106 in the field and/or to automatically replace the bad batch of drums/belts 106 in the field. A drum/belt batch comprises a group of drums or belts that were manufactured together during a single production run. The drums or belts of a batch may be installed in multiple machines 102 of system 100. At each machine, the voltage based bare belt readings may be taken at different points during an image print or copy job by the ESVs. For example, voltage based bare belt readings may be taken when there is no image on a drum or belt. These voltage based bare belt readings may be referred to as Vresidual readings. Additionally or alternatively, voltage based bare belt readings may be taken after charge and discharge operations are performed by the machine. These voltage based bare belt readings may be referred to as Vmeasured readings.

The voltage based bare belt readings (e.g., Vresidual or Vmeasured) taken during a given time period at one or more machines may be obtained from memory and combined to compute a mean bare belt reading and/or a standard deviation. For example, the stored values for the voltage based bare belt readings taken over the last M days, weeks and/or month may be obtained for one or more machines. M is any number equal to or greater than one. The mean bare belt reading and/or standard deviation may be computed periodically or in response to a trigger event. The trigger event may include, but is not limited to, an installation of a drum or belt in a machine of system 100 and/or expiration of defined time period starting from the installation time of the drum or belt in the machine of the system 100.

The mean bare belt reading and/or standard deviation is/are then compared to threshold value(s). The threshold value(s) may be selected in accordance with any given application. For example, the threshold mean value may be 12 for a mean Vresidual value and/or the threshold value may be 8 for a standard deviation of Vresidual readings. The threshold mean value may be 130 for a mean Vmeasured value or 30 for a standard deviation of Vmeasured readings. The present solution is not limited to the listed threshold values.

The controller 130 and/or a remote computing device 150 may then make a conclusion as to whether the given drum/belt batch is a good batch or a bad batch. A good drum/belt batch conclusion may be made when the computed mean value is equal to or less than the threshold value and/or the computed standard deviation is equal to or less than the threshold value. A bad drum/belt batch conclusion may be made when the computed mean value is equal to or greater than the threshold value and/or the computed standard deviation is equal to or greater than the threshold value. Based on the conclusion, controller 130 and/or a remote computing device 150 may perform operations to, for example, issue a notification, issue a warning, and/or automatically replace the drum(s) or belt(s) in the machine(s) 102. The notification and/or warning may be only cleared when a new drum or belt is installed on the machine and/or its barcode scanned.

The drum(s) or belt(s) may be automatically replaced by controlling automatic consumable replacer(s) 158 in the machine(s). The automatic consumable replacer(s) 158 may be configured to: retrieve a replacement consumable 156 from a storage compartment; replace the consumable with the retrieved replacement consumable 156; and/or dispose of the replaced consumable. The automatic consumable replacer(s) 158 can include, but are not limited to, articulating arm(s), gripper(s), and/or mechanical transporter(s) (e.g., conveyer belt(s)).

In some scenarios, controller 130 and/or a remote computing device 150 may be configured to: detect bare belt ESV voltage shifts (mean) and variability increases (standard deviation) as a function of PR or drum batch; and/or detect exposed belt ESV voltage at K station shifts (mean) and variability increases (standard deviation) as a function of drum or belt batch. The conclusion as to whether the given drum/belt batch is a good batch or a bad batch may then be made based on one or both of these detections.

Image quality (IQ) degradation due to a drum/belt batch defect often translates into frequent replacements that significantly increase run costs. The present solution may also involve reconfiguring one or more machines when a bad batch of drums or belts is detected to reduce the IQ degradation. For example, the system may adjust (e.g., increase or decrease) a laser power level for a raster output scanner. The present solution is not limited in this regard.

Controller 130 and/or a remote computing device 150 may also be configured to use the light based bare belt readings in machines to detect, predict, warn and/or replace a bad batch of toner cartridges. A toner batch comprises a group of toner cartridges or bottles that were manufactured together during a single production run. The toner cartridges of a given batch may be installed in multiple machines 102 of system 100. These voltage readings may be made by light measuring devices such as the ETACS sensors. The light based bare belt readings may be made by an ETAC in a location labeled as “background patch”.

Controller 130 and/or a remote computing device 150 may be configured to use the light based bare belt readings made by the ETACS to compute a relative reflectance (RR) variability and/or mean for a specific toner batch. The RR variability can include, but is not limited to, an RR standard deviation and/or an RR range. Each toner cartridge in the toner batch has a unique batch number that identifies it as part of that group. For example, a unique batch number for a given group of magenta toner cartridges can be 22963. Each magenta toner cartridge in the group as a unique identifier. A first magenta toner cartridge may be associated with a unique string of numbers 22963.01, while a second magenta toner cartridge may be associated with another unique string of numbers 22963.02 and so on. The present solution is not limited in this regard. Other unique identifiers can be used here. Accordingly, the light based bare belt readings may be stored in local or remote memory so as to be associated with the unique toner batch number and/or the unique toner cartridge number.

The light based bare belt readings taken during a given time period at one or more machines may be obtained from memory and combined to compute an RR variability value and/or a mean voltage value. For example, the stored values for the voltage based bare belt readings taken over the last J days, weeks and/or month may be obtained for one or more machines. J is any number equal to or greater than one. The RR variability value and/or mean voltage value may be computed periodically or in response to a trigger event. Any known or to be known technique for computing a standard deviation and/or mean can be used here. The trigger event may include, but is not limited to, an installation of a toner cartridge in a machine of system 100 and/or expiration of defined time period starting from the installation time of the toner cartridge in the machine of the system 100.

The RR variability value and/or a mean voltage value is/are then compared to threshold value(s). The threshold value(s) may be selected in accordance with any given application. For example, the threshold RR variability value may be 0.05 and/or the threshold mean voltage value may be 0.02. The present solution is not limited to the listed threshold values.

The controller 130 and/or a remote computing device 150 may then make a conclusion as to whether the given toner batch is a good batch or a bad batch. A good toner batch conclusion may be made when the computed RR variability value is equal to or less than the threshold RR variability value and/or the computed mean voltage value is equal to or less than the threshold mean voltage value.

Illustrative examples for the toner scenarios are provided the following TABLES 1-2.

TABLE 1
Batch #1 (Magenta), Threshold =
0.05 for RR StdDev and RR Range

| | Bare Belt | RR | RR | Batch Type |
|---|---|---|---|---|
| Machine | Readings | StdDev | Range | Assignment |
| MC1 | 0.005 | 0.006 | 0.020 | Good Toner |
| MC2 | 0.001 | | | Batch |
| MC3 | 0.010 | | | |
| MC4 | 0.001 | | | |
| MC5 | −0.010 | | | |
| MC6 | 0.005 | | | |
| MC7 | −0.002 | | | |
| MC8 | 0.005 | | | |
| MC9 | 0.004 | | | |

TABLE 2
Batch #2 (Yellow), Threshold =
0.05 for RR StdDev and RR Range

| | Bare Belt | RR | RR | Batch Type |
|---|---|---|---|---|
| Machine | Readings | StdDev | Range | Assignment |
| MC3 | 0.003 | 0.064 | 0.176 | Bad Toner |
| MC4 | 0.001 | | | Batch |
| MC5 | 0.014 | | | |
| MC6 | 0.172 | | | |
| MC7 | 0.006 | | | |
| MC8 | 0.000 | | | |
| MC9 | −0.004 | | | |

It should be noted that, in some scenarios, the system may require bare belt readings for at least a specified number of machines in order to make a batch type assignment or determination. For example, the system may require bare belt readings for three or more machines in order to make a decision as to the batch type based on an RR standard deviation and/or an RR range. When bare belt readings are available only for one or two machines, the system may not perform the RR variability computations or discard the results of the RR variability computation(s). This scenario is shown in the following TABLE 3.

TABLE 3
Batch #3 (Yellow), Threshold =
0.05 for RR StdDev and RR Range

| | Bare Belt | RR | RR | Batch Type |
|---|---|---|---|---|
| Machine | Readings | StdDev | Range | Assignment |
| MC10 | 0.100 | 0.057 | 0.080 | Discard, only |
| MC11 | 0.020 | | | two machines |

Based on the conclusion, controller 130 and/or a remote computing device 150 may perform operations to, for example, issue a notification, issue a warning, and/or automatically replace the toner cartridge(s) in the machine(s) 102. The notification and/or warning may be only cleared when a new toner cartridge is installed on the machine and/or its barcode scanned.

The present solution may also involve (re)prioritizing print and/or copy jobs based on print/copy type and/or reconfiguring one or more machines when a bad batch of toner cartridges is detected. For example, the system may prioritize relatively higher coverage image print/copy jobs over relatively lower coverage print/copy jobs. The print/copy jobs may then be re-ordered in accordance with the relative priorities assigned to the print/copy jobs. Additionally, the system may adjust (e.g., increase or decrease) a toner concentration parameter value and/or a toner purge threshold value. The present solution is not limited in this regard.

The present solution has many advantages. For example, the present solution uses the power of the fleet to flag consumables that are producing signals that are abnormal to the known process. The present solution provides a method that is: applicable to large fleets (small or large volume) such as office products, or high-volume fleets (small or large fleets) such as production products; and real-time, data-driven to predict if/when a bad photoreceptor or drum batch reaches the machines in the field (MIF). The present solution also: minimizes engineers/service from expensive long escalations while also advancing knowledge in a predictive way; and saves companies money by minimizing potential service calls due to bad batch of photoreceptors or drums. The present solution also advances artificial intelligence (AI) methods in printers and/or multi-functional devices.

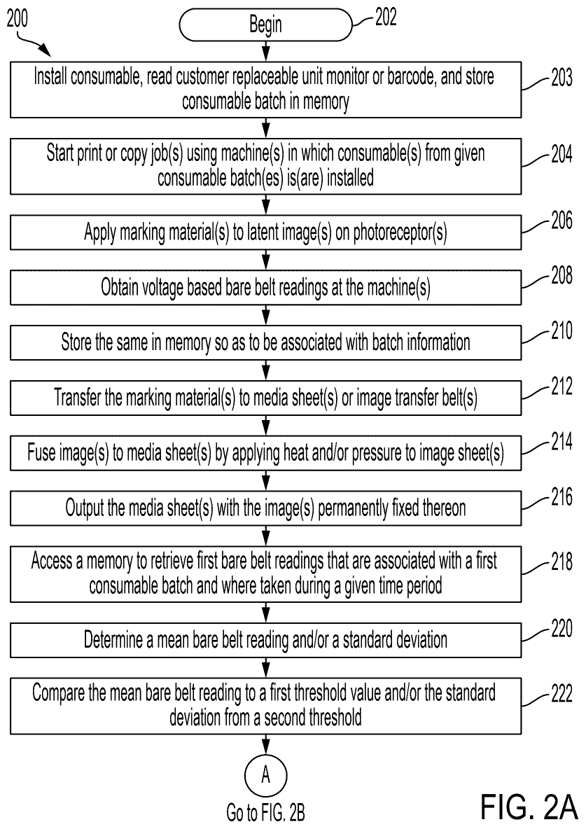

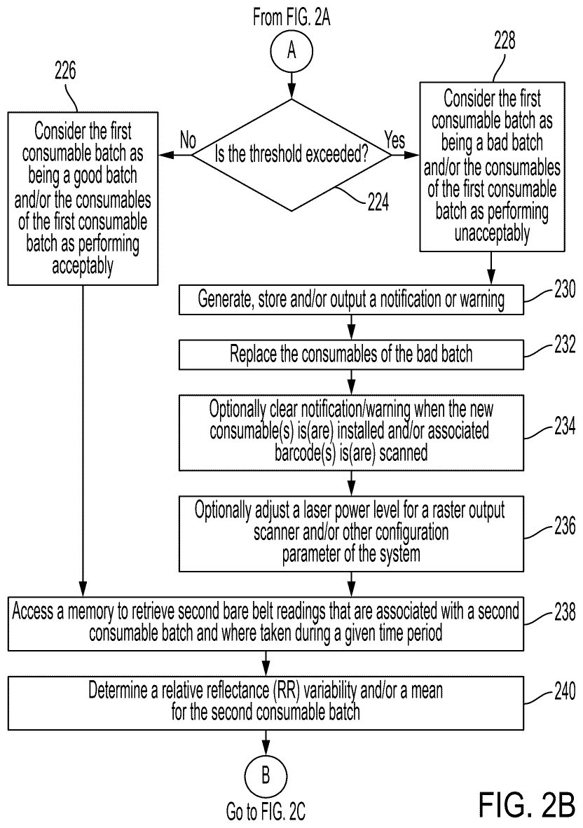

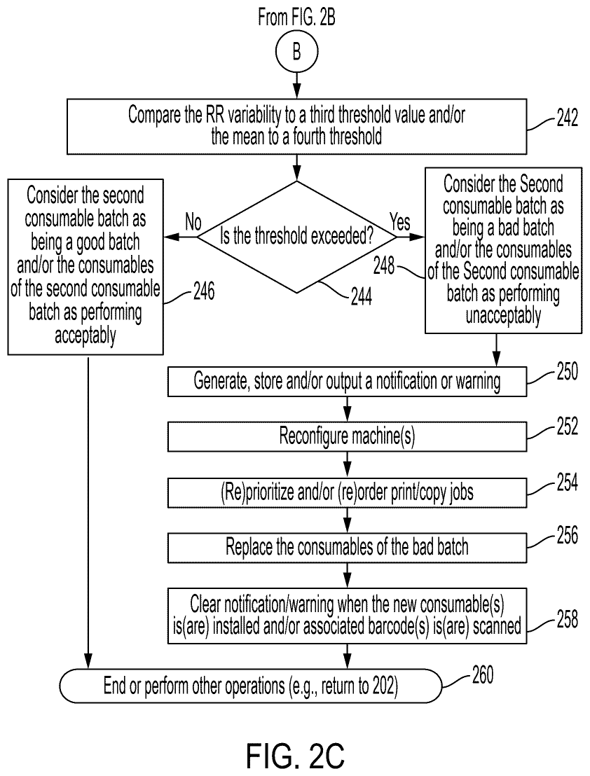

FIG. 2 provides a flow diagram of an illustrative method 200 for operating a system in accordance with the present solution. Method 200 may be implemented by system 100 of FIG. 1. Method 200 can include more or less operations than that shown in FIG. 2. For example, the operations of blocks 218-236 or blocks 238-258 may be removed from the method. Additionally or alternatively, the operations of method 200 may be performed in a different order than that shown. For example, the operations of blocks 238-258 may be performed before the operations of blocks 218-236 rather than after as shown in FIG. 2.

Method 200 begins with block 202 and continues to block 203. In block 203, a consumable(s) is (are) installed. The consumable(s) include, but are not limited to, toner, photoreceptor belt, and/or photoreceptor drum. In the toner scenario, a customer replaceable unit monitor (CRUM) is automatically read. In the photoreceptor belt and drum scenarios, a barcode is read manually. Consumable batch information is then stored in memory.

Next in bock 204, a print or copy job is started using machine(s) (e.g., machine(s) 102 of FIG. 1) in which consumable(s) from given consumable batch(es) is (are) installed. For example, each machine may have a toner cartridge from a given toner batch installed therein and/or a drum/belt from a given drum/belt batch installed therein. The present solution is not limited to the listed types of consumables. Other types of consumables may also be installed on or in the machine(s).

In the scenario where the machine(s) is (are) xerographic device(s), method 200 continues with 206 where marking material(s) is (are) applied on PR(s) (e.g. PR(s) 104 of FIG. 1). Voltage based bare belt readings are obtained at the machine(es) during the print/copy job(s). The voltage based bare belt readings can be obtained using voltage measuring device(s) (e.g., sensor(s) 132 of FIG. 1). The voltage measuring device(s) can include, but is (are) not limited to, ESV(s) and ETACS(s). The voltage based bare belt readings are stored in memory so as to be associated with batch information, as shown by block 210. The memory may be local to the machine(s) and/or remote from the machine(s). The batch information can include, but is not limited to, batch identifier(s), consumable identifier(s), consumable type(s), and/or manufacturing date(s). The batch information may be used index(es) to obtain the voltage based bare belt readings from memory.

Next in block 212, the marking material(s) is (are) transferred to media sheet(s) or image transfer block(s). The image(s) is (are) fused in block 214 to the media sheet(s) by applying heat and/or pressure to the image sheet(s). The media sheet(s) with the image(s) permanently fixed thereon is (are) output in block 216.

In block 218, a computing device accesses the memory (ies) to retrieve first bare belt readings that are associated with a first consumable batch which were taken during a given time period. The computing device can include, but is not limited to, a machine controller (e.g., controller 130 of FIG. 1) and/or a server (e.g., computing device 150 of FIG. 1). The first consumable batch can comprise, for example, a drum or belt batch. The given period of time can include, for example, hour(s), day(s), week(s), and/or month(s).

The first bare belt readings are then used in block 220 by the computing device to determine a mean bare belt reading and/or a standard deviation. Any known or to be known techniques for determining a mean and/or a standard deviation can be used here. The mean bare belt reading may then be compared to a first threshold value in block 222. Additionally or alternatively, the standard deviation may be compared to a second threshold in block 222. Thereafter, method 200 continues to block 224 of FIG. 2B.

As shown in FIG. 2B, block 224 involves deciding by the computing device whether the threshold value(s) was (were) exceeded. If not [224: NO], then the computing device considers the first consumable batch as being a good batch and/or considers the consumables of the first consumable batch as performing acceptably. Method 200 continues to block 238 which will be discussed below.

If so [224: YES], then the computing device considers the first consumable batch as being a bad batch and/or considers the consumables of the first consumable batch as performing unacceptably. In this case, the computing device can take one or more actions. Such actions can include, but are not limited to: (230) generating, storing and/or outputting a notification or warning of the bad batch and/or unacceptably performing consumable(s); (232) causing the manual replacement of or automatically replacing the unacceptably performing consumable(s); (234) clearing the notification or warning when the new consumable(s) is (are) installed in the machine(s) and/or associated barcode(s) is (are) scanned; (236) adjusting a laser power level for a raster output scanner and/or other configuration parameter of the system. Method 200 then continues with block 238.

In block 238, the computing device accessing memory (ies) to retrieve second bare belt readings that are associated with a second consumable batch and were taken during a given period of time. The second consumable batch can comprise, for example, a toner batch. The given period of time can include, for example, hour(s), day(s), week(s), and/or month(s). This given period of time may be the same as or different than the period of time referenced in block 218. The second bare belt readings are used by the computing device in block 240 to determine an RR variability and/or a mean for the second consumable batch. Method 220 continues with block 242 of FIG. 2C.

As shown in FIG. 2C, block 242 involves comparing the RR variability to a third threshold and/or comparing the mean to a fourth threshold. The computing device then decides in block 244 whether the third and/or fourth threshold(s) was (were) exceeded. If not [244: NO], the computing device considers the second consumable batch as being a good batch and/or the consumables of the second consumable batch as performing acceptably, as shown by block 246. Method 200 continues to block 260 where it ends or other operations are performed (e.g., return to block 202 of FIG. 2A).

If so [244: YES], then the computing device considers the second consumable batch as being a bad batch and/or the consumables of the second consumable batch as performing unacceptably, as shown by block 246. In this case, the computing device can take one or more actions. Such actions can include, but are not limited to: (250) generating, storing and/or outputting a notification or warning of the bad batch and/or unacceptably performing consumable(s); (252) reconfiguring the machine(s) by adjusting one or more configuration parameters thereof; (254) (re)prioritizing and/or (re)ordering print/copy jobs, for example, based on content type (e.g., image or text) and/or coverage amount (e.g., the amount of a media sheet that is to be covered by toner and/or ink during a print/copy job); (256) causing the manual replacement of or automatically replacing the unacceptably performing consumable(s); and/or (258) clearing the notification or warning when the new consumable(s) is (are) installed in the machine(s) and/or associated barcode(s) is (are) scanned. Method 200 then continues with block 260 where it ends or other operations are performed (e.g., return to block 202 of FIG. 2A).

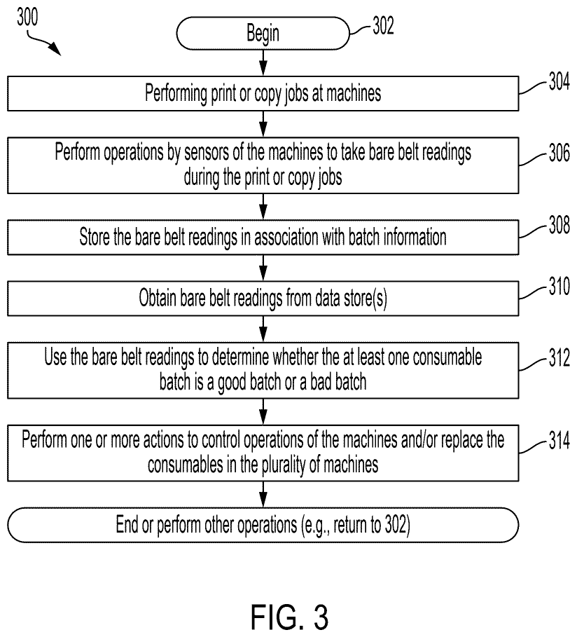

FIG. 3 provides a flow diagram of an illustrative method 300 for a system (e.g., system 100 of FIG. 1) including a plurality of machines (e.g., machines 102 of FIG. 1) having consumables (e.g., toner cartridges 152, PRs 104, and/or drums/belts 106 of FIG. 1) of at least one consumable batch installed therein. Method begins at block 302 and continues to block 304 where the machines perform print or copy jobs. Next in 306, sensors (e.g., sensors 132 of FIG. 1) of the machines perform operations to take bare belt readings during the print or copy jobs. The bare belt readings are stored in block 308. The voltage bare belt readings are stored in association with batch information. The batch information provides an index for retrieving the voltage bare belt readings from memory and the batch information comprises at least an identifier for the consumable batch.

In block 310, a computing device (e.g., controller 130 and/or computing device 150 of FIG. 1) obtains bare belt readings from datastore(s) (e.g., local memory (ies) of the computing device and/or remote memory (e.g., a database)). The computing device uses the bare belt readings in block 312 to determine whether the consumable batch is a good batch or a bad batch. This determination may be made by: determining a metric value based on the voltage based bare belt readings; comparing the metric value to a threshold value; and determining that the at least one consumable batch is a good batch when the metric value is less than the threshold value or determining that the at least one consumable batch is a bad batch when the metric value is greater than the threshold value. The metric value can include, but is not limited to, a mean, a standard deviation, or a relative reflectance.

In block 314, the computing device performs one or more actions to control operations of the plurality of machines and/or replace the consumables in the plurality of machines in response to a determination that the at least one consumable batch is a bad batch. The actions can include, but is not limited to, outputting a notification or warning of the bad batch, adjusting laser power levels of lasers in the plurality of machines, prioritizing or re-ordering print or copy jobs for the plurality of machines, and/or reconfiguring the plurality of machines by adjusting one or more configuration parameter values of the plurality of machines. The configuration parameter values can include, but are not limited to, toner concentration parameter value(s) and/or toner purge threshold value(s). Subsequently, method 300 continues to block 316 where it ends or other operations are performed (e.g., return to block 302).

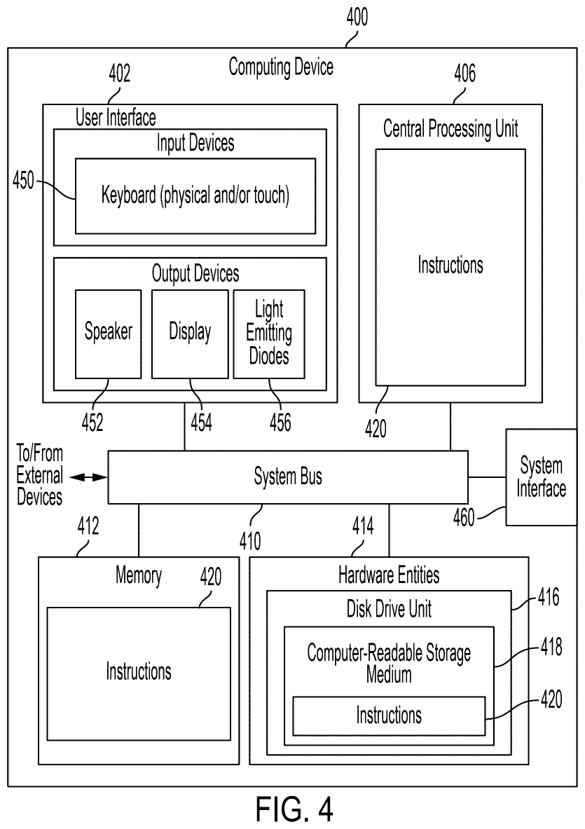

Referring now to FIG. 4, there is shown an illustrative architecture for a computing device 400. The controller 130 of FIG. 1 and computing device 150 of FIG. 1 is/are the same as or similar to computing device 400. As such, the discussion of computing device 400 is sufficient for understanding the controller 130 of FIG. 1 and/or computing device 150 of FIG. 1.

Computing device 400 may include more or less components than those shown in FIG. 4. However, the components shown are sufficient to disclose an illustrative solution implementing the present solution. The hardware architecture of FIG. 4 represents one implementation of a representative computing device configured to receive information, process the receive information, transmit information and/or control operations of an aerial vehicle, as described herein. As such, the computing device 400 of FIG. 4 implements at least a portion of the method(s) described herein.

Some or all components of the computing device 400 can be implemented as hardware, software and/or a combination of hardware and software. The hardware includes, but is not limited to, one or more electronic circuits. The electronic circuits can include, but are not limited to, passive components (e.g., resistors and capacitors) and/or active components (e.g., amplifiers and/or microprocessors). The passive and/or active components can be adapted to, arranged to and/or programmed to perform one or more of the methodologies, procedures, or functions described herein.

As shown in FIG. 4, the computing device 400 comprises a user interface 402, a Central Processing Unit (CPU) 406, a system bus 410, a memory 412 connected to and accessible by other portions of computing device 400 through system bus 410, a system interface 460, and hardware entities 414 connected to system bus 410. The user interface can include input devices and output devices, which facilitate user-software interactions for controlling operations of the computing device 400. The input devices include, but are not limited to, a physical and/or touch keyboard 450. The input devices can be connected to the computing device 400 via a wired or wireless connection (e.g., a Bluetooth® connection). The output devices include, but are not limited to, a speaker 452, a display 454, and/or light emitting diodes 456. System interface 460 is configured to facilitate wired or wireless communications to and from external devices (e.g., network nodes such as access points, etc.).

At least some of the hardware entities 414 perform actions involving access to and use of memory 412, which can be a Random Access Memory (RAM), a disk drive, flash memory, and/or another hardware device that is capable of storing instructions and data. Hardware entities 414 can include a disk drive unit 416 comprising a computer-readable storage medium 418 on which is stored one or more sets of instructions 420 (e.g., software code) configured to implement one or more of the methodologies, procedures, or functions described herein. The instructions 420 can also reside, completely or at least partially, within the memory 412 and/or within the CPU 406 during execution thereof by the computing device 400. The memory 412 and the CPU 406 also can constitute machine-readable media. The term “machine-readable media”, as used here, refers to a single medium or multiple media (e.g., a centralized or distributed database, and/or associated caches and servers) that store the one or more sets of instructions 420. The term “machine-readable media”, as used here, also refers to any medium that is capable of storing, encoding or carrying a set of instructions 920 for execution by the computing device 400 and that cause the computing device 400 to perform any one or more of the methodologies of the present disclosure.

In view of the forgoing, the present solution concerns an implementing system and a method for operating a system (e.g., system 100 of FIG. 1) including a plurality of machines (e.g., machines 102 of FIG. 1) having consumables (e.g., toner cartridges 152, photoreceptors 104, and/or drums/belts 106 of FIG. 1) of at least one consumable batch installed therein. The method comprises: performing print or copy jobs at the plurality of machines; performing operations by sensors (e.g., sensors 132 of FIG. 1) to take voltage or light based bare belt readings during the print or copy jobs; storing the voltage and light based bare belt readings in association with batch information (wherein the batch information provides an index for retrieving the voltage bare belt readings from memory and the batch information comprises at least an identifier for the at least one consumable batch); obtaining, by a computing device (e.g., controller 130 and/or computing device 150 of FIG. 1), voltage or light based bare belt readings taken by the sensors one or more print or copy processes performed by the plurality of machines; using, by the computing device, the voltage or light based bare belt readings to determine whether the at least one consumable batch is a good batch or a bad batch; and/or performing, by the computing device, one or more actions to control operations of the plurality of machines and/or replace the consumables in the plurality of machines in response to a determination that the at least one consumable batch is a bad batch. The plurality of machines can include, but are not limited to, xerographic devices. The consumables can include, but are not limited to, toner cartridges, photoreceptors, drums and/or belts. The sensors can include, but are not limited to, electrostatic voltmeters (ESVs) and/or extended toner area coverage sensors (ETACS).

A determination as to whether the at least one consumable batch is a good batch or a bad batch may be made by: determining a metric value based on the voltage or light based bare belt readings; comparing the metric value to a threshold value; and determining that the at least one consumable batch is a good batch when the metric value is less than the threshold value or determining that the at least one consumable batch is a bad batch when the metric value is greater than the threshold value. The metric value can include, but is not limited to, a mean, a standard deviation, or a range.

The one or more actions may comprise: outputting a notification or warning of the bad batch; adjusting laser power levels of lasers in the plurality of machines; prioritizing or re-ordering print or copy jobs for the plurality of machines; and/or reconfiguring the plurality of machines by adjusting one or more configuration parameter values of the plurality of machines. The configuration parameter values can include, but are not limited to, a toner concentration parameter value and/or a toner purge threshold value.

The present solution also concerns a system comprising: a plurality of machines having consumables of at least one consumable batch installed therein and sensors that take voltage based bare belt readings during print or copy jobs; a processor; and a non-transitory computer-readable medium. The non-transitory computer-readable medium comprises one or more programming instructions that when executed by the processor, cause the processor to: obtain the voltage based bare belt readings taken by the sensors during one or more print or copy processes performed by the plurality of machines; use the voltage or light based bare belt readings to determine whether the at least one consumable batch is a good batch or a bad batch; and perform one or more actions to control operations of the plurality of machines and/or replace the consumables in the plurality of machines in response to a determination that the at least one consumable batch is a bad batch. The machines can include, but are not limited to, xerographic devices. The consumables can include, but are not limited to, toner cartridges, and/or photoreceptor drums/belts. The sensors can include, but are not limited to, electrostatic voltmeters (ESVs) and/or extended toner area coverage sensors (ETACS).

The voltage or light bare belt readings may be stored in a datastore in association with batch information. The batch information may provide an index for retrieving the voltage bare belt readings from memory and the batch information comprises at least an identifier for the at least one consumable batch.

The determination as to whether the at least one consumable batch is a good batch or a bad batch may be made by: determining a metric value based on the voltage or light based bare belt readings; comparing the metric value to a threshold value; and considering the at least one consumable batch to comprise a good batch when the metric value is less than the threshold value or considering the at least one consumable batch to comprise a bad batch when the metric value is greater than the threshold value. The metric value can include, but is not limited to, a mean, a standard deviation, or range.

The action(s) can include, but are not limited to, outputting a notification or warning of the bad batch, adjusting laser power levels of lasers in the plurality of machines, prioritizing or re-ordering print or copy jobs for the plurality of machines, and/or reconfiguring the plurality of machines by adjusting one or more configuration parameter values of the plurality of machines. The configuration parameter values can include, but are not limited to, a toner concentration parameter value and/or a toner purge threshold value.

As used in this document, the singular form “a”, “an”, and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to”.

The described features, advantages and characteristics disclosed herein may be combined in any suitable manner. One skilled in the relevant art will recognize, in light of the description herein, that the disclosed systems and/or methods can be practiced without one or more of the specific features. In other instances, additional features and advantages may be recognized in certain scenarios that may not be present in all instances.

Although the systems and methods have been illustrated and described with respect to one or more implementations, equivalent alterations and modifications will occur to others skilled in the art upon the reading and understanding of this specification and the annexed drawings. In addition, while a particular feature may have been disclosed with respect to only one of several implementations, such feature may be combined with one or more other features of the other implementations as may be desired and advantageous for any given or particular application. Thus, the breadth and scope of the disclosure herein should not be limited by any of the above descriptions. Rather, the scope of the invention should be defined in accordance with the following claims and their equivalents.

What is claimed is:

1. A method for operating a system including a plurality of machines having consumables of at least one consumable batch installed therein, comprising:
obtaining, by a computing device, voltage or light based bare belt readings taken by sensors during one or more print or copy processes performed by the plurality of machines;
using, by the computing device, the voltage or light based bare belt readings to determine whether the at least one consumable batch is a good batch or a bad batch; and
performing, by the computing device, one or more actions to control operations of the plurality of machines and/or replace the consumables in the plurality of machines in response to a determination that the at least one consumable batch is a bad batch.

2. The method according to claim 1, wherein the plurality of machines comprises xerographic devices.

3. The method according to claim 1, wherein the consumables comprise toner cartridges, and/or photoreceptor drums/belts.

4. The method according to claim 1, wherein the sensors comprise electrostatic voltmeters (ESVs) and/or extended toner area coverage sensors (ETACS).

5. The method according to claim 1, further comprising:
performing print or copy jobs at the plurality of machines;
performing operations by the sensors to take voltage or light based bare belt readings during the print or copy jobs; and
storing the voltage or light based bare belt readings in association with batch information;
wherein the batch information provides an index for retrieving the voltage or light based bare belt readings from memory and the batch information comprises at least an identifier for the at least one consumable batch.

6. The method according to claim 1, wherein the using the voltage or light based bare belt readings to determine whether the at least one consumable batch is a good batch or a bad batch comprises:
determining a metric value based on the voltage or light based bare belt readings;
comparing the metric value to a threshold value; and
determining that the at least one consumable batch is a good batch when the metric value is less than the threshold value or determining that the at least one consumable batch is a bad batch when the metric value is greater than the threshold value.

7. The method according to claim 6, wherein the metric value comprises a mean, a standard deviation, or rang.

8. The method according to claim 1, wherein the one or more actions comprises outputting a notification or warning of the bad batch.

9. The method according to claim 1, wherein the one or more actions comprises:
adjusting laser power levels of lasers in the plurality of machines;
prioritizing or re-ordering print or copy jobs for the plurality of machines; and/or
reconfiguring the plurality of machines by adjusting one or more configuration parameter values of the plurality of machines.

10. The method according to claim 9, wherein one or more configuration parameter values comprises a toner concentration parameter value and/or a toner purge threshold value.

11. A system, comprising:
a plurality of machines having consumables of at least one consumable batch installed therein and sensors that take voltage based bare belt readings during print or copy jobs;
a processor; and
a non-transitory computer-readable medium comprising one or more programming instructions that when executed by the processor, cause the processor to:
obtain the voltage or light based bare belt readings taken by the sensors during one or more print or copy processes performed by the plurality of machines;
use the voltage or light based bare belt readings to determine whether the at least one consumable batch is a good batch or a bad batch; and
perform one or more actions to control operations of the plurality of machines and/or replace the consumables in the plurality of machines in response to a determination that the at least one consumable batch is a bad batch.

12. The system according to claim 11, wherein the plurality of machines comprises xerographic devices.

13. The system according to claim 11, wherein the consumables comprise toner cartridges, and/or photoreceptor drums/belts.

14. The system according to claim 11, wherein the sensors comprise electrostatic voltmeters (ESVs) and/or extended toner area coverage sensors (ETACS).

15. The system according to claim 11, wherein the voltage or light based bare belt readings are stored in a datastore in association with batch information, the batch information providing an index for retrieving the voltage or light based bare belt readings from memory and the batch information comprises at least an identifier for the at least one consumable batch.

16. The system according to claim 11, wherein a determination as to whether the at least one consumable batch is a good batch or a bad batch is made by:
determining a metric value based on the voltage or light based bare belt readings;
comparing the metric value to a threshold value; and
considering the at least one consumable batch to comprise a good batch when the metric value is less than the threshold value or considering the at least one consumable batch to comprise a bad batch when the metric value is greater than the threshold value.

17. The system according to claim 16, wherein the metric value comprises a mean, a standard deviation, or range.

18. The system according to claim 11, wherein the one or more actions comprises outputting a notification or warning of the bad batch.

19. The system according to claim 11, wherein the one or more actions comprises:
adjusting laser power levels of lasers in the plurality of machines;
prioritizing or re-ordering print or copy jobs for the plurality of machines; and/or
reconfiguring the plurality of machines by adjusting one or more configuration parameter values of the plurality of machines.

20. The system according to claim 19, wherein one or more configuration parameter values comprises a toner concentration parameter value and/or a toner purge threshold value.
